(19) United States
(12) Patent Application Publication
(10) Pub. No.: US 2026/0292777 A1
(43) Pub. Date: Sep. 24, 2026

(54) VERFAHREN ZUM BETRIEB EINES ORTUNGSSYSTEMS UND MANAGEMENT-LAYER-EINRICHTUNG FÜR EIN ORTUNGSSYSTEM

(71) Applicant: TRUMPF TRACKING TECHNOLOGIES GMBH, Donaueschingen (DE)

(72) Inventors: Franz LEHMANN, Dresden (DE); Stephan BRAEUNIG, Dresden (DE); Frank STEPHAN, Dresden (DE); Danny SCHUMANN, Dresden (DE)

(21) Appl. No.: 19/570,084

(22) Filed: Mar. 17, 2026

(30) Foreign Application Priority Data
Mar. 18, 2025 (DE) 102025110486.7

(51) Int. Cl. H04W 64/00; H04W 76/10

(52) U.S. Cl. CPC H04W 64/00; H04W 76/10

(57) ABSTRACT

The invention relates to a method for operating a localization system for determining a position (Po1, Po2) of at least one tag (T1, T2), wherein the localization system comprises a management layer service (MD), at least one first cluster (C1) having a plurality of first anchors (S11, S12, S13, S14) and at least one second cluster (C2) having a plurality of second anchors (S21, S22, S23, S24), wherein the clusters (C1, C2) are configured differently from one another, preferably at least with respect to a communication protocol and/or a communication technology. The invention further relates to a management layer device (ME) for a localization system for determining a position (Po1, Po2) of at least one tag (T1, T2), wherein the localization system comprises at least one first cluster (C1) having a plurality of first anchors (S11, S12, S13, S14) and at least one second cluster (C2) having a plurality of second anchors (S21, S22, S23, S24), wherein the clusters (C1, C2) are configured differently from one another, preferably at least with respect to a communication protocol and/or a communication technology.

The present invention is in the field of localization systems for mobile objects and relates to a method for operating a localization system for determining a position of at least one tag. Furthermore, the present invention relates to a management layer device for a localization system for determining a position of at least one tag.

Localization systems for determining a position and/or a movement of a mobile object within a specific spatial region are configured differently in dependence on their area of application and purpose of use and must fulfill a large number of requirements.

In the field of localization systems, there are inter alia communication standards for realizing a sufficiently precise and reliable position determination of mobile objects. The communication standard “FiRa” (abbreviation for “Fine Ranging”), for example, comprises a communication protocol that was developed by the FiRa Consortium. “FiRa”, for example, enables the determination of positions of mobile objects such as smartphones in a wide variety of fields of application. “FiRa” specifies the use of a radio communication technology based on a combination of the so-called ultra-wideband technology (abbreviated to “UWB technology”) and the so-called Bluetooth technology, in particular the so-called Bluetooth Low Energy technology (abbreviated to “BLE technology”), in order to enable a sufficiently precise and reliable determination of the position (localization).

The “omlox” communication standard comprises a further communication protocol in the field of localization systems. “omlox” uses a combination of UWB and an IEEE802.15.4-based data channel to enable a determination of positions of mobile objects in industrial and professional environments that is robust and as deterministic as possible. In addition, “omlox” allows the integration of various other radio communication technologies, such as Bluetooth, RFID (abbreviation for “radio-frequency identification”), GPS (abbreviation for “Global localization system”) or WLAN (abbreviation for “Wireless Local Area Network”) as complementary localization technologies in order to enable a good determination of positions of mobile objects. “omlox” is, for example, used for applications in logistics, healthcare and the process industry or can, for example, be used for so-called asset tracking.

A so-called management layer, which is tailored to the respective communication technology or the respective communication protocol, is usually used to operate a localization system. A management layer is a central logical layer that takes over the setup, administration and control. The management layer, for example, controls the synchronization of the infrastructure and further central services.

Increasingly, localization systems are being used that are based on different communication technologies and/or that use different communication protocols to be able to meet respective requirements. Each communication technology or each communication protocol is assigned its own management layer that is specifically coordinated with the respective communication technology or the respective communication protocol.

However, the use of differently coordinated and thus differently configured management layers, for example, leads to additional effort and causes unnecessary costs. Furthermore, differently configured management layers can lead to problems when determining the position of a mobile object that, for example, performs a zone change, which is accompanied by a change of the communication technology or the communication protocol. A zone change of the localization system can, for example, take place on a spatial transition of a mobile object, for example in the form of an industrial truck, from an indoor area inside a building to an outdoor area outside the building.

It is an object of the present invention to provide a method for operating a localization system with different communication protocols and/or communication technologies, said method being improved with respect to the determination of a position of a mobile object, in particular on a change of the communication technology in the course of a zone change of the mobile object. Furthermore, it is an object of the present invention to provide a management layer device that is configured to operate a localization system with different communication protocols and/or communication technologies in the same zone.

This object is satisfied by the features of independent claims 1 and 12. Further embodiment examples and applications of the present invention result from the dependent claims and are explained in more detail in the following description with partial reference to the figures.

According to a first general aspect, the present invention relates to a method for operating a localization system for determining a position of at least one tag, wherein the localization system comprises a management layer service, at least one first cluster having a plurality of first anchors and at least one second cluster having a plurality of second anchors, wherein the clusters at least partly overlap with respect to their coverage area and are configured differently from one another, preferably at least with respect to a communication protocol and/or a communication technology, said method comprising: a) establishing a communication link between the management layer service and the plurality of first anchors; b) establishing a communication link between the management layer service and the plurality of second anchors; c) synchronizing the plurality of first anchors and/or the plurality of second anchors, orchestrated by the management layer service in each case; d) establishing a communication link between the plurality of first anchors, preferably the plurality of synchronized first anchors, and the plurality of second anchors, preferably the synchronized plurality of second anchors, by means of the management layer service in order to ensure a defined determination of the position of the at least one tag at least across the at least one first and the at least one second cluster substantially continuously and/or substantially consistently.

A method for operating a localization system for determining a position of at least one tag can be provided by the present invention, said method being improved when using differently configured clusters, which are, for example, based on different communication protocols and/or communication technologies, in that a communication link is established between respective anchors of the at least one first cluster and the at least one second cluster, a synchronization is orchestrated by the (identical) management layer service in each case, and a communication link is established between the anchors, which are synchronized with one another in each case, by means of the management layer service. Accordingly, the management layer service is preferably a single and/or a shared and/or a central management layer service. The management layer service is configured to orchestrate the synchronization of differently configured clusters so that a plurality of (individually configured) management layer services for respective clusters can be avoided or are unnecessary. Furthermore, the management layer service is preferably configured to establish a communication link between differently configured clusters.

The at least one tag (also referred to as a “transponder” or “marker”) can be an active tag and can send a signal. Alternatively, the at least one tag can be a passive tag and can reflect a signal. The at least one tag can be at least one of the following and/or can comprise at least one of the following: a UWB tag, a BLE tag, a UWB/BLE tag, an RFID tag, a WLAN tag. Further configurations of at least one tag are possible. The at least one tag can be arranged as a transponder at a mobile object. The mobile object can, for example, be an industrial truck (for example in the form of a forklift truck) or a mobile, handheld end device (for example in the form of a smartphone or a tablet).

An anchor (also referred to as a “reference point”, a “satellite” or a “beacon”) is preferably a spatially fixedly installed communication device (for example with a defined and/or known position) that can form a wireless communication link with the at least one tag. An anchor can be at least one of the following and/or comprise one of the following: a UWB anchor, a BLE anchor, a UWB/BLE anchor, an RFID anchor, a WLAN anchor. Further configurations of the anchor are possible. The plurality of first anchors of the at least one first cluster and the plurality of second anchors of the at least one second cluster are preferably logically separated from one another. It is possible that at least one first anchor and at least one second anchor are each arranged at the same defined and/or known position. It is possible that at least one first anchor and at least one second anchor form an anchor unit (also designated as a “localization hub”).

A plurality of anchors, which are configured with respect to a common communication technology and/or with respect to a common communication protocol, can be combined into a cluster and/or can be assigned to a cluster. The cluster is characterized by a plurality of anchors. The arrangement or configuration of the plurality of anchors preferably forms a topology which is assigned to the cluster and/or by which the cluster is characterized. In other words, a topology is formed by a plurality of anchors.

A respective communication technology and/or a respective communication protocol can be assigned to and/or can at least be based on at least one of the following communication technologies: UWB technology, BLE technology, RFID technology, WLAN technology, GPS/GNSS technology, ultrasonic technology, optical technology, etc.

A coverage area of a cluster preferably defines that spatial zone within which the plurality of anchors of the respective cluster can transmit, receive and/or process signals in order to determine the position of the at least one tag. The coverage area can, for example, be defined by the transmission and reception power of the plurality of anchors, the reception characteristics of the at least one tag and by physical conditions in the environment (for example, obstacles, materials, etc.).

The orchestration of the synchronization of the plurality of first anchors and/or the plurality of second anchors, in each case by the management layer service, comprises, for example, initiating, maintaining and/or terminating a coordination for coordinating the plurality of anchors of a respective cluster in a time aspect. The orchestration can be dynamic in dependence on the respective cluster and/or its change of the configuration, for example if an anchor fails.

According to a further aspect of the present invention, provision can be made that the synchronization takes place in a defined order in dependence on a respective topology of the at least one first cluster and/or the at least one second cluster, preferably to shorten a synchronization duration, wherein preferably the defined order is characterized in sections by a tree-shaped course and/or in sections by a cascade-shaped course, and/or wherein preferably the defined order and/or the respective topology is/are defined by a spatial arrangement and/or by communication addresses, preferably MAC communication addresses, of the plurality of first anchors and the plurality of second anchors. For example, the synchronization of an “omlox”-based cluster could be used for a “FiRa”-based cluster with partly identical physical but logically separate anchors.

The defined order can comprise a progression of the synchronization, said progression being adjacent with respect to the anchors. A cascade-shaped course preferably comprises a synchronization of the respective plurality of anchors in a defined order, wherein an anchor is synchronized with a previously synchronized anchor. In other words, a cascade-shaped course represents a sequential synchronization of anchors. A tree-shaped course preferably comprises a synchronization of the respective plurality of anchors according to a hierarchical structure, wherein an anchor is synchronized with a respective higher-level anchor of a corresponding priority. A synchronization of the respective plurality of anchors according to a tree-shaped course and thus according to a hierarchical structure can be at least partly temporally decoupled from one another, which is accompanied, for example, by a shortening of the synchronization. As a result, anchors can, for example, be synchronized substantially simultaneously, and thus substantially at the same time, outside their transmission and reception range without interfering in so doing.

It is possible for the synchronization to take place in a defined sequential manner, in a defined superposed manner and/or in a defined periodic manner in dependence on a respective topology of the at least one first cluster and/or of the at least one second cluster, preferably starting from a respective reference anchor of the plurality of first anchors and the plurality of second anchors.

A defined sequential synchronization can, for example, comprise a temporally upstream synchronization of the at least one first cluster before the at least one second cluster, for example in the case of mutually independent tasks of the at least one first cluster and the at least one second cluster. A defined superposed synchronization can, for example, comprise a temporally at least partly overlapping synchronization of the at least one first cluster and the at least one second cluster. A defined periodic synchronization can comprise a synchronization of the at least one first cluster and/or the at least one second cluster after a defined time period in each case.

The method can comprise: changing and/or adapting a respective topology of the at least one first cluster and/or of the at least one second cluster by means of the management layer service in order to minimize and/or substantially avoid a propagation of timing errors between respective anchors of the plurality of first anchors and/or the plurality of second anchors.

It is possible for the synchronization to take place in dependence on a respective priority of the anchors within the at least one first cluster and/or of the anchors within the at least one second cluster, wherein preferably the respective priority is dynamically defined by the management layer service.

Due to the synchronization of anchors in dependence on a respective priority within a cluster, a more precise, more efficient and more stable determination of the position of at least one tag can, for example, be realized. This can take place, for example, in the course of a zone change of the at least one tag between the at least one first cluster and the at least one second cluster.

The synchronization can comprise: generating at least one synchronization signal, which comprises at least one piece of time stamp information and/or at least one piece of correction value information, which information is in each case detected by means of a bidirectional communication link of mutually adjacent anchors, in order to dynamically adjust the synchronization and/or to set a time synchronization of the plurality of anchors in dependence on the generated at least one synchronization signal, wherein preferably the at least one piece of time stamp information comprises a time difference, a transit time and/or a phase shift, and/or wherein preferably the at least one piece of correction value information serves to compensate for transit time differences.

The method can comprise: executing a setup mode by means of the management layer service to detect at least one further cluster having a plurality of further anchors; determining at least one further topology of the at least one further cluster in dependence on at least one setup signal; and repeating the method steps b), c) and d) with respect to the at least one further cluster.

As a result, the method can, for example, be dynamically adapted to a changed localization system comprising respective clusters. As a result, for example, no further (separate) management layer service is required either.

The method can comprise: determining the positions of the further anchors in dependence on the at least one setup signal and/or retrieving the positions of the further anchors; configuring and/or adapting the communication link with those further anchors that, in dependence on their determined and/or retrieved position, lie outside a defined communication range in order to ensure a substantially continuous communication link and/or substantially interference-free communication.

For example, a defined transmission power and/or reception power of respective anchors can be set in order to improve a range and/or reliability of the communication link between anchors and the at least one tag and/or between respective anchors among one another or to meet regulatory requirements.

The method can comprise: dividing the at least one first cluster and/or the at least one second cluster into in each case at least one first sub-cluster and at least one second sub-cluster that each have a defined number of anchors of the plurality of first anchors and/or the plurality of second anchors; and repeating the method steps c) and d) with respect to the at least one first and second sub-cluster in each case.

The method can comprise: merging the at least one first sub-cluster and the at least one second sub-cluster as soon as and/or if a synchronization of the defined number of anchors of the plurality of first anchors and/or the plurality of second anchors has taken place.

The defined determination of the position of the at least one tag can, for example, take place by means of least one of the following methods: trilateration, preferably in combination with ultra-wideband (UWB) technology; triangulation, preferably in combination with Bluetooth Low Energy (BLE) technology.

Of course, other methods are also possible, for example, RSSI-based fingerprinting (RSSI as an abbreviation for “Received Signal Strength Indicator”).

According to a second general aspect, the present invention relates to a management layer device for a localization system for determining a position of at least one tag, wherein the localization system comprises at least one first cluster having a plurality of first anchors and at least one second cluster having a plurality of second anchors, wherein the clusters at least partly overlap with respect to their coverage area and are configured differently from one another, preferably at least with respect to a communication protocol and/or a communication technology, wherein the management layer device is configured: a) to establish a communication link with the plurality of first anchors; b) to establish a communication link with the plurality of second anchors; c) to orchestrate a synchronization of the plurality of first anchors and/or the plurality of second anchors; d) to establish a communication link between the plurality of first anchors, preferably the synchronized plurality of first anchors, and the plurality of second anchors, preferably the synchronized plurality of second anchors, in order to ensure a defined determination of the position of the at least one tag at least across the at least one first and the at least one second cluster substantially continuously and/or substantially consistently, wherein preferably the management layer device is configured to perform a method as disclosed herein.

The management layer device is preferably a central device. The management layer device can be configured to provide a single and/or a central management layer service as disclosed herein. The management layer service can be executed on the management layer device. The management layer service and thus the management layer device can be configured for synchronization and for establishing a communication link between the at least one first cluster and the at least one second cluster.

According to a further aspect of the present invention, provision can be made that the management layer device comprises a central interface unit that is configured to convert and/or translate respective communication signals of the communication links with the plurality of first anchors and with the plurality of second anchors in dependence on the configuration of the respective other cluster in order to establish compatibility between the communication links.

According to a third general aspect, the present invention relates to a computer program product that comprises a computer program code that is stored on a machine-readable medium and/or that is represented by at least one electromagnetic wave that comprises at least one computer program code segment of the computer program code, wherein the computer program code comprises computer-executable instructions for performing a method for operating a localization system as disclosed herein, preferably upon execution on a management layer device as disclose therein.

According to a further general aspect, the present invention can relate to a localization system for determining a position of at least one tag that is configured as disclosed herein, that is configured to perform the method as disclosed herein and/or that comprises a management layer device as disclosed herein.

To avoid repetition, features that are directed purely to the apparatus of the management layer device according to the invention and/or that are disclosed in connection therewith should also be deemed to be disclosed according to the method and claimable, and vice versa.

The embodiment examples and features of the present invention described above can be combined with one another as desired or as appropriate. Further or other details and advantageous effects of the present invention are explained in more detail below with reference to the enclosed figures.

There are shown:

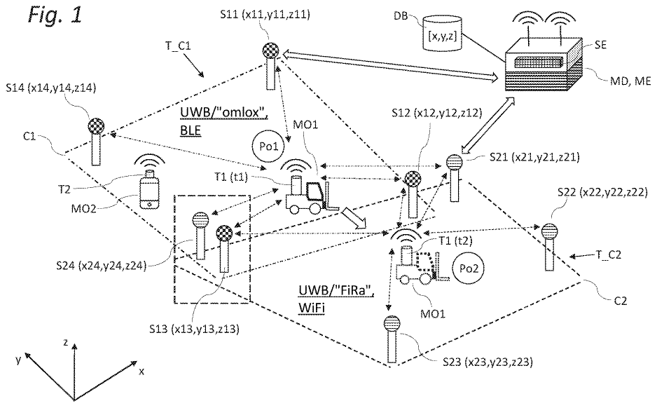

FIG. 1 shows, in a schematic representation, a first localization system that can be operated with the method according to the present invention, wherein the localization system comprises a management layer device and a management layer service according to the present invention;

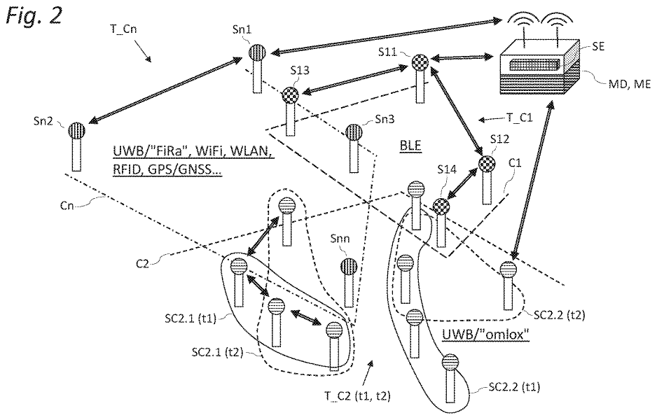

FIG. 2 shows, in a schematic representation, a second localization system that can be operated with the method according to the present invention, wherein the localization system comprises a management layer device and a management layer service according to the present invention; and

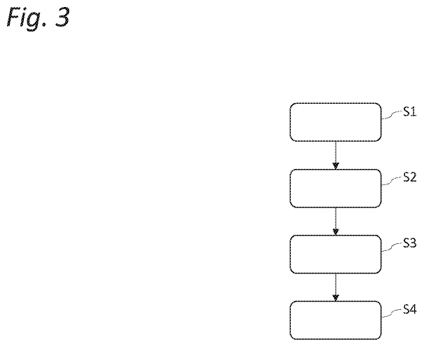

FIG. 3 a flowchart of a first embodiment example of the method according to the present invention.

Components or elements that are the same or functionally equivalent are marked by the same reference numerals in the Figures. For their explanation, reference is also made in part to the description of other embodiment examples and/or figures in order to avoid repetitions.

The following detailed description of the embodiment examples shown in the Figures serves for a more detailed illustration or clarification and is in no way intended to limit the scope of the present invention.

FIG. 1 shows, in a schematic representation, a first localization system that can be operated with the method according to the present invention and/or that is configured to carry out the method according to the present invention. The localization system can be designed and/or configured as a localization system according to the invention.

The localization system comprises a first cluster C1 and a second cluster C2. The first cluster C1 comprises a plurality of first anchors S11, S12, S13, S14 and the second cluster C2 comprises a plurality of second anchors S21, S22, S23, S24. To illustrate the assignment of the first and second anchors S11, S12, S13, S14, S21, S22, S23, S24 to the respective cluster C1, C2 and of the associated coverage area of the respective cluster C1, C2, a chain-dotted line and a dashed line are each shown symbolically as a demarcation line in FIG. 1. For example, the first cluster C1 can be located inside a production hall of the process industry and the second cluster C2 can be located outside this production hall (masked in the Figures for reasons of clarity).

The anchors S11, S12, S13, S14, S21, S22, S23, S24 are arranged at defined and/or known positions as reference points of the respective cluster C1, C2 for determining a tag T1, T2. The defined and/or known positions are illustrated by the specifications of respective coordinate values (x11,y11,z11) for the anchor S11 to (x24,y24,z24) for the anchor S24 of a reference coordinate system x, y, z. The defined and/or known positions can be stored in a database DB of the localization system. In terms of their coverage area, the first cluster C1 and the second cluster C2 at least partly overlap. The coverage area of the first cluster C1 defines a first spatial zone within which the anchors S11, S12, S13, S14 can transmit, receive and/or process signals in order to determine the position of tags T1, T2. The same applies to the coverage area of the second cluster C2 with the anchors S21, S22, S23, S24.

It is also possible for an anchor to belong to both the first cluster and the second cluster. Such an anchor is referred to below as a double anchor. In this example, a double anchor can combine the two anchors S13 of the first cluster C1 and the anchor S24 of the second cluster C2. This is indicated by the dashed lines in FIG. 1. The coordinates of the anchor S13 and the anchor S24 are then identical. A time-slot method is preferably used for the association of the double anchor with the clusters. The double anchor then belongs alternately to the first cluster C1 during one time slot and to C2 during a second time slot. The double anchor uses the communication standard of the corresponding cluster for communication during the time slots. Within the first cluster C1, the double anchor is recognized as anchor S13 and, within the second cluster S24, the double anchor is recognized as anchor S24.

The anchors S11, S12, S13, S14 of the first cluster C1 together form a first topology T_C1 and the anchors S21, S22, S23, S24 of the second cluster C2 together form a second topology T_C2. Each of the anchors S11, S12, S13, S14, S21, S22, S23, S24 can be characterized by a defined priority within the respective cluster C1, C2, for example in dependence on the spatial arrangement, i.e. the respective defined and/or known position. In other words, the anchors S11, S12, S13, S14, S21, S22, S23, S24 can be characterized by a respective different priority among one another. Each of the anchors S11, S12, S13, S14, S21, S22, S23, S24 can be characterized and/or identifiable by a communication address assigned to it, preferably a MAC communication address.

The first cluster C1 and the second cluster C2 are configured differently from one another. The first cluster C1 is configured with respect to a first communication protocol and/or a first communication technology and the second cluster C2 is configured with respect to a second communication protocol and/or a second communication technology. In the embodiment example shown, the first cluster C1 is, for example, configured according to UWB technology (for example based on “omlox”) and/or according to BLE technology, wherein a defined determination of the position Po1 of the tag T1 at a point in time t1 takes place by means of ultra-wideband radio communication technology and/or by means of Bluetooth low energy radio communication technology.

Therefore, a defined determination of the position of the at least one tag T1 by the first cluster C1 can, for example, take place by the method of trilateration, preferably in combination with UWB technology, and/or by the method of triangulation, preferably in combination with BLE technology, wherein corresponding signal propagation times and/or angles of the signal reception are detected in dependence on the method and/or the radio communication technology in each case.

The second cluster C2 is, for example, configured according to UWB technology (for example based on “FiRa”) and/or WiFi technology (radio technology based on the 802.11 standard), wherein a defined determination of the position Po2 of the tag T1 at a point in time t2 takes place by means of UWB (for example based on “FiRa”) and/or by means of WiFi technology. A defined determination of the position of the at least one tag T1 by the second cluster C2 can therefore take place by means of the method of trilateration.

The tag T1 is arranged as a transponder, for example, at an industrial truck in the form of a forklift truck as a mobile object MO1 that can be moved or is moved spatially between the clusters C1 and C2, which is accompanied by a change in the coverage area of the respective cluster C1, C2. In addition, a further tag T2 is shown in FIG. 1 that is, for example, arranged at a mobile object MO2 in the form of a smartphone or tablet.

The localization system comprises a management layer device ME according to the invention and/or a management layer service MD according to the invention. The management layer device ME is configured to provide the management layer service MD in order to perform a method for operating the localization system to determine the position Po1, Po2 of the tag T1 and/or the tag T2. The management layer device ME can be partly formed and/or realized in hardware and/or in software. The management layer device ME is a central and/or shared and/or single management layer device ME for the localization system.

The management layer device ME is configured to establish a communication link with the plurality of first anchors S11, S12, S13, S14 of the first cluster C1 and a communication link with the plurality of second anchors S21, S22, S23, S24 of the second cluster C2. The management layer device ME preferably comprises a central interface unit SE for this purpose. The central interface unit SE is configured to convert and/or translate respective communication signals of the communication links with the plurality of first anchors S11, S12, S13, S14 and with the plurality of second anchors S21, S22, S23, S24 in dependence on the configuration of the respective cluster C1, C2 in order to establish compatibility between the communication links.

The management layer device ME is configured to orchestrate a synchronization of the first cluster C1 and/or the second cluster C2 in each case and to establish a communication link according to a method as disclosed herein. The synchronization of the clusters C1 and C2 can, as disclosed herein, be performed substantially simultaneously, successively in time and/or at least partly overlapping in time in order to subsequently, after a communication link between respective anchors S11, S12, S13, S14, S21, S22, S23, S24 has been established, on a corresponding zone change of the mobile object MO1, to ensure a defined determination of the position Po1, Po2 of the tag T1 at respective points in time t1, t2 across the first cluster C1 and across the second cluster C2 substantially continuously and/or substantially consistently, preferably without interruptions, disturbances or error states.

FIG. 2 shows, in a schematic and further simplified representation, a second localization system that can be operated with the method according to the present invention and/or that is configured to perform the method according to the present invention.

The localization system comprises a first cluster C1 having the four anchors S11, S12, S13, S14 that together form a first topology T_C1. The localization system comprises a second cluster C2 having respective anchors that are not labeled in detail for reasons of clarity. The second cluster C2 serves to illustrate the division of at least a part of the second cluster C2 into sub-clusters SC2.1 and SC2.2, each having a defined number of anchors, at respective different points in time t1, t2 in the course of the orchestration of the synchronization by the management layer service MD of the management layer device ME, which is further accompanied by the formation of a different topology T_C2 for the second cluster C2.

In addition, a further cluster Cn with the respective topology T_Cn, which is formed by the anchors Sn1, Sn2, Sn3 and Snn, is shown as an example. The further cluster Cn can be based on a different communication technology to the clusters C1 and C2 or on a different communication protocol.

Each cluster C1, C2, Cn can be configured differently with respect to a communication protocol and/or a communication technology (see in this respect the abbreviations specified in FIG. 2 in each case).

Due to the method according to the present invention, a communication link can be established between each cluster C1, C2, Cn, and in particular a respective synchronization of anchors can be performed, by means of a single and/or a central management layer service MD and/or by means of a single and/or a central management layer device ME.

FIG. 3 shows a flowchart of a first embodiment example of the method according to the present invention.

The method begins with the method step S1 with the establishing of a communication link between the management layer service MD and the plurality of first anchors S11, S12, S13, S14 of a first cluster C1 (see in addition hereto, for example, FIG. 1 and the associated explanations).

In the method step S2, an establishing of a communication link between the management layer service MD and the plurality of second anchors S21, S22, S23, S24 of a second cluster C2 takes place (see in addition hereto, for example, FIG. 1 and the associated explanations).

In the method step S3, a synchronization of the plurality of first anchors S11, S12, S13, S14 of the first cluster C1 and/or the plurality of second anchors S21, S22, S23, S24 of the second cluster C2 is orchestrated by the management layer service MD. The synchronization of the respective anchors S11, S12, S13, S14, S21, S22, S23, S24 and/or clusters C1, C2 can be performed as disclosed herein.

For example, by means of the orchestration by the management layer service MD, a synchronization of the respective anchors S11, S12, S13, S14, S15, S21, S22, S23, S24 can take place in dependence on a respective topology T1, T2 of the first and second cluster C1, C2 in a defined order. The defined order can, in a schematic representation, be characterized in sections by a tree-shaped course and/or in sections by a cascade-shaped course. The defined order can be defined by a spatial arrangement and/or by a communication address of a respective anchor S11, S12, S13, S14, S15, S21, S22, S23, S24.

The method step S3 can be carried out as disclosed herein.

Due to the synchronization and/or after the synchronization by means of the orchestration by the management layer service MD, a communication link can be established in method step S4 between the plurality of first anchors S11, S12, S13, S14 and the plurality of second anchors S21, S22, S23, S24, and thus between the first cluster C1 and the second cluster C2, in order to ensure a defined determination of the position of a tag T1, T2 at least across the first and the second cluster C1, C2 substantially continuously and/or substantially consistently.

Further additional and/or modified method steps, i.e. sections and phases of the method, are possible within the scope of the present disclosure. Furthermore, it is also possible that method steps disclosed herein can, when carrying out the method, be carried out at least partly parallel in time and/or also in a temporally different order. It is further possible to appropriately combine the further method steps disclosed herein in accordance with the present invention that are not mentioned as part of the description of the Figures.

The present invention is not restricted to the embodiment examples described above. Rather, a plurality of variants and modifications are possible that likewise make use of the inventive concept and are therefore covered by the scope of protection. Preferably, the present invention also claims protection for the subject matter and the features of the dependent claims independently of the referenced claims.

### REFERENCE NUMERAL LIST

C1 cluster
C2 cluster
Cn cluster
DB database
MO1 mobile object
MO2 mobile object
MD management layer service
Po1 position
Po2 position
SE interface unit
S11 anchor
S12 anchor
S13 anchor
S14 anchor
S21 anchor
S22 anchor
S23 anchor
S24 anchor
Sn1 anchor
Sn2 anchor
Sn3 anchor
Snn anchor
SC2.1 sub-cluster
SC2.2 sub-cluster
T_C1 topology
T_C2 topology
T_Cn topology
T1 tag
T2 tag
t1 point in time
t2 point in time
x position coordinate
y position coordinate
Z position coordinate

1-14. (canceled)

15. A method for operating a localization system for determining a position of at least one tag, wherein the localization system comprises a management layer service, at least one first cluster having a plurality of first anchors and at least one second cluster having a plurality of second anchors, wherein the clusters at least partly overlap with respect to their coverage area and are configured differently from one another, said method comprising:
a) establishing a communication link between the management layer service and the plurality of first anchors;
b) establishing a communication link between the management layer service and the plurality of second anchors;
c) synchronizing the plurality of first anchors and/or the plurality of second anchors, orchestrated by the management layer service in each case;
d) establishing a communication link between the plurality of first anchors and the plurality of second anchors by means of the management layer service in order to ensure a defined determination of the position of the at least one tag at least across the at least one first and the at least one second cluster continuously and/or consistently.

16. The method according to claim 15,
wherein the synchronization takes place in a defined order in dependence on a respective topology of the at least one first cluster and/or the at least one second cluster.

17. The method according to claim 15,
wherein the synchronization takes place in a defined sequential manner, in a defined superposed manner and/or in a defined periodic manner in dependence on a respective topology of the at least one first cluster and/or of the at least one second cluster.

18. The method according to claim 15, comprising:
changing and/or adapting a respective topology of the at least one first cluster and/or of the at least one second cluster by means of the management layer service in order to minimize a propagation of timing errors between respective anchors of the plurality of first anchors and/or the plurality of second anchors.

19. The method according to claim 15,
wherein the synchronization takes place in dependence on a respective priority of the anchors within the at least one first cluster and/or the anchors within the at least one second cluster.

20. The method according to claim 15,
wherein the synchronization comprises:
generating at least one synchronization signal, which comprises at least one piece of time stamp information and/or at least one piece of correction value information, which information is in each case detected by means of a bidirectional communication link of mutually adjacent anchors, in order to dynamically adjust the synchronization and/or to set a time synchronization of the plurality of anchors in dependence on the generated at least one synchronization signal.

21. The method according to claim 1, comprising:
executing a setup mode by means of the management layer service to detect at least one further cluster having a plurality of further anchors;
determining at least one further topology of the at least one further cluster in dependence on at least one setup signal; and
repeating the method steps b), c) and d) with respect to the at least one further cluster.

22. The method according to claim 21, comprising:
determining the positions of the further anchors in dependence on the at least one setup signal and/or retrieving the positions of the further anchors;
configuring and/or adapting the communication link with those further anchors that, in dependence on their determined and/or retrieved position, lie outside a defined communication range in order to ensure a continuous communication link and/or interference-free communication.

23. The method according to claim 15, comprising:
dividing the at least one first cluster and/or the at least one second cluster into in each case at least one first sub-cluster and at least one second sub-cluster that each have a defined number of anchors of the plurality of first anchors and/or the plurality of second anchors; and
repeating the method steps c) and d) with respect to the at least one first and second sub-cluster in each case.

24. The method according to claim 23, comprising:
merging the at least one first sub-cluster and the at least one second sub-cluster as soon as a synchronization of the defined number of anchors of the plurality of first anchors and/or the plurality of second anchors has taken place.

25. The method according to claim 15,
wherein the defined determination of the position of the at least one tag takes place by means of at least one of the following methods:
trilateration;
trilateration in combination with ultra-wideband technology;
triangulation;
triangulation in combination with Bluetooth Low Energy technology.

26. A management layer device for a localization system for determining a position of at least one tag, wherein the localization system comprises at least one first cluster having a plurality of first anchors and at least one second cluster having a plurality of second anchors, wherein the clusters at least partly overlap with respect to their coverage area and are configured differently from one another,
wherein the management layer device is configured:
a) to establish a communication link with the plurality of first anchors;
b) to establish a communication link with the plurality of second anchors;
c) to orchestrate a synchronization of the plurality of first anchors and/or the plurality of second anchors;
d) to establish a communication link between the plurality of first anchors and the plurality of second anchors in order to ensure a defined determination of the position of the at least one tag at least across the at least one first and the at least one second cluster continuously and/or consistently.

27. A management layer device according to claim 26,
wherein the management layer device comprises a central interface unit that is configured to convert and/or translate respective communication signals of the communication links with the plurality of first anchors and with the plurality of second anchors in dependence on the configuration of the respective other cluster in order to establish compatibility between the communication links.

28. A computer program product that comprises a computer program code that is stored on a machine-readable medium and/or that is represented by at least one electromagnetic wave that comprises at least one computer program code segment of the computer program code,
wherein the computer program code comprises computer-executable instructions for performing a method for operating a localization system according to claim 15.

29. The method according to claim 15,
wherein the clusters at least partly overlap with respect to their coverage area and are configured differently from one another, at least with respect to a communication protocol and/or a communication technology.

30. The method according to claim 16,
wherein the defined order is characterized in sections by a tree-shaped course and/or in sections by a cascade-shaped course, and/or
wherein the defined order and/or the respective topology is/are defined by a spatial arrangement and/or by communication addresses of the plurality of first anchors and the plurality of second anchors.

31. The method according to claim 17,
wherein the synchronization takes place in a defined sequential manner, in a defined superposed manner and/or in a defined periodic manner in dependence on a respective topology of the at least one first cluster and/or of the at least one second cluster, starting from a respective reference anchor of the plurality of first anchors and the plurality of second anchors.

32. The method according to claim 19,
wherein the respective priority is dynamically defined by the management layer service.

33. The method according to claim 20,
wherein the at least one piece of time stamp information comprises a time difference, a transit time and/or a phase shift, and/or
wherein the at least one piece of correction value information serves to compensate for transit time differences.

34. The computer program product according to claim 27,
wherein the computer program code performs said method upon execution on a management layer device, the management layer device for a localization system for determining a position of at least one tag, wherein the localization system comprises at least one first cluster having a plurality of first anchors and at least one second cluster having a plurality of second anchors, wherein the clusters at least partly overlap with respect to their coverage area and are configured differently from one another, wherein the management layer device is configured:
a) to establish a communication link with the plurality of first anchors;
b) to establish a communication link with the plurality of second anchors;
c) to orchestrate a synchronization of the plurality of first anchors and/or the plurality of second anchors;
d) to establish a communication link between the plurality of first anchors and the plurality of second anchors in order to ensure a defined determination of the position of the at least one tag at least across the at least one first and the at least one second cluster continuously and/or consistently.
